(19) United States
(12) Patent Application Publication
(10) Pub. No.: US 2026/0250502 A1
(43) Pub. Date: Aug. 27, 2026

(54) ETHYLENE/ALPHA-OLEFIN MULTI-BLOCK INTERPOLYMER-BASED COMPOSITIONS WITH EXCELLENT BALLY FLEX RESISTANCE

(71) Applicant: Dow Global Technologies LLC, Midland, MI (US)

(72) Inventors: Yunfeng Yang, Shanghai (CN); Xuejun Liu, Shanghai (CN)

(21) Appl. No.: 18/871,241

(22) PCT Filed: Sep. 2, 2022
(86) PCT No.: PCT/CN2022/116766

§ 371 Date: Dec. 3, 2024

(51) Int. Cl. C08L 53/00

(52) U.S. Cl. CPC C08L 53/00

(57) ABSTRACT

A composition comprising a first composition, and wherein the first composition comprises the following components a and b: a) at least one ethylene/alpha-olefin multi-block interpolymer that comprises a density≤0.880 g/cc and a soft segment melting temperature (SS-Tm)≤2.0° C.; b) at least one propylene-based polymer; and wherein component a is present in an amount ≥88 wt %, a based on the sum weight of components a and b.

### BACKGROUND OF THE INVENTION

Polyolefin elastomer (POE) based artificial leather is thought to be an eco-friendly and a sustainable leather product Compared with incumbent PVC (polyvinyl chloride) leather, POE leather is halogen free and also free of “phthalate like” plasticizers. Compared with another conventional PU (polyurethane) leather, no harmful solvent (for example, DMF) is needed during the POE leather manufacturing process. Thus, POE leather production is greener, which brings minimal water/air/soil pollution. Although PUD (aqueous polyurethane dispersion) and solvent-free PU are becoming popular, POE leather still has the advantage of easy recyclability, due to its thermoplastic nature. From the point of view of performance. POE has excellent weatherability and low temperature flexibility, and minimal or no hydrolysis and yellowing issues. In addition, POE leather can more easily meet the lightweight trend in luggage/bag, shoe and auto applications, because POE density is much lower than PVC (by approx. 40%) and PU (by approx. 25%). Thus, POE leather will be a promising product to replace PVC leather and PU leather in several applications.

Bally Flex resistance, a characterization of durability and mechanical fatigue during a cyclic flexural stress, is a critical performance property of leather products in most applications. From a benchmark study, it was discovered that POE typically is not as good as PU and PVC in terms of Bally Flex resistance at room temperature. Particularly, the typical Bally flex resistance of the INFUSE Olefin Block Copolymers (for example, ethylene/octene multi-block copolymers) is low. However, such polymers are a required enabler/component for POE artificial leather, because they provide high heat resistance and softness (hand feel), both critical properties for artificial leathers. It is noted that such polymers can provide high heat resistance and softness, at the same time, since they provide a decoupling of the melting point from the modulus. Therefore, it is desirable to improve the Bally Flex resistance of ethylene/alpha-olefin multi-block interpolymers, and there is a need for compositions, containing the same, with improved Bally Flex resistance.

U.S. Publication 2012/0108134 discloses artificial leather comprising a multilayer structure comprising the following: A) a top skin layer comprising a propylene/alpha-olefin copolymer and at least one of the following: (i) a styrenic block copolymer, (ii) a homogeneously branched ethylene/alpha-olefin copolymer, (iii) an olefin block copolymer, and (iv) a random polypropylene copolymer; B) a middle foam layer comprising a propylene/alpha olefin copolymer and at least one of the following: (i) a styrenic block copolymer, (ii) a homogeneously branched ethylene/alpha-olefin copolymer, (iii) an olefin block copolymer, and (iv) a random polypropylene copolymer; and C) a bottom fabric layer comprising a nonwoven, polymeric spun bound material (see, for example, abstract and claim 1). Olefin block copolymers are described, for example, in paragraphs [0070] and [0071].

U.S. Pat. No. 8,921,491 discloses an impact modified composition comprising ethylene-alpha-olefin (block) interpolymers characterized by an average block index, ABI, which is greater than zero and up to about 1.0, and a molecular weight distribution, MWD, greater than about 1.3. In addition, or alternatively, the block ethylene/alpha-olefin interpolymer is characterized by having at least one fraction obtained by Temperature Rising Elution Fractionation (TREF), and wherein the fraction has a block index greater than about 0.3 and up to about 1.0, and the ethylene/alpha-olefin interpolymer has a molecular weight distribution, MWD, greater than about 1.4 (see abstract). The “soft segment Tm (° C.) from weighted DSC” of several of polymers are listed in Table 16 (see column 72, lines 6-29). See, for example, Table 27 (column 81), Table 32(column 85) and Table 38 (column 86) for compositions containing a propylene-based polymer.

U.S. Pat. No. 7,893,166 discloses a class of ethylene/alpha-olefin block interpolymers characterized by an average block index, ABI, which is greater than zero and up to about 1.0, and a molecular weight distribution, MWD, greater than about 1.3. Preferably, the block index is from about 0.2 to about 1. In addition, or alternatively, the block ethylene/alpha-olefin interpolymer is characterized by having at least one fraction obtained by Temperature Rising Elution Fractionation (TREF), wherein the fraction has a block index greater than about 0.3 and up to about 1.0, and the ethylene/alpha-olefin interpolymer has a molecular weight distribution, MWD, greater than about 1.3 (see Abstract). The “soft segment Tm (° C.) from weighted DSC” of several polymers are listed in Table 16 (see column 60, lines 11-35). This patent discloses polymers for blending, which include polypropylene (see for example, column 25, lines 11-33). See also U.S. Pat. No. 7,608,668.

Additional compositions containing olefin multi-block copolymers are disclosed in the following references: U.S. Pat. No. 7,592,397 (see, for example, the compositions of Tables 12 and 13 (columns 73-76)), and International Publication WO 2014/036292 (see, for example, the compositions of Table 3, paragraph [103]).

However, as discussed above, there remains a need for ethylene/alpha-olefin multi-block interpolymer-based compositions with improved Bally Flex resistance. This need has met by the following invention.

### SUMMARY OF THE INVENTION

A composition comprising a first composition, and wherein the first composition comprises the following components a and b:
a) at least one ethylene/alpha-olefin multi-block interpolymer that comprises a density 5 0.880 g/cc and a soft segment melting temperature (SS-Tm)≤2.0° C.;
b) at least one propylene-based polymer; and

wherein component a is present in an amount≥88 wt %, based on the sum weight of components a and b.

### BRIEF DESCRIPTION OF THE DRAWINGS

FIG. 1 depicts the “Melt Enthalpy (J/g) versus Temperature (° C.)” for linear copolymers as described herein.

### DETAILED DESCRIPTION OF THE INVENTION

Compositions have been discovered that have excellent Bally Flex resistance and good softness, and are well suited for artificial rubber. As discussed above, a composition is provided, which comprises a first composition comprises the following components a and b:
a) at least one ethylene/alpha-olefin multi-block interpolymer that comprises a density 5 0.880 g/cc and a soft segment melting temperature (SS-Tm)≤2.0° C.;
b) at least one propylene-based polymer, and

wherein component a is present in an amount 288 wt %, based on the sum weight of components a and b.

The above composition may comprise a combination of two or more embodiments, as described herein. Each component of the composition may comprise a combination of two or more embodiments, as described herein.

In one embodiment, or a combination of two or more embodiments, each described herein, the ethylene/alpha-olefin multi-block interpolymer (of component a) has a density≥0.855 g/cc, or ≥0.858 g/cc, or ≥0.860 g/cc, or ≥0.862 g/cc, or ≥0.864 g/cc, or ≥0.866 g/cc, or ≥0.868 g/cc, or ≥0.869 g/cc. In one embodiment, or a combination of two or more embodiments, each described herein, the ethylene/alpha-olefin multi-block interpolymer (of component a) has a density≤0.880 g/cc, or ≤0.878 g/cc, or ≤0.876 g/cc, or ≤0.874 g/cc, or ≤0.872 g/cc, or ≤0.871 g/cc, or ≤0.870 g/cc.

In one embodiment, or a combination of two or more embodiments, each described herein, the ethylene/alpha-olefin multi-block interpolymer (of component a) has a SS-Tm≤2.0° C., or ≤1.5° C., or ≤1.0° C., or ≤0.8° C., or ≤0.6° C., or ≤0.4° C., or ≤0.2° C., or ≤0.1° C., or ≤0.0° C., or ≤−0.5° C., or ≤−1.0° C., or ≤−2.0° C., or ≤−5.0° C., or ≤−8.0° C. In one embodiment, or a combination of two or more embodiments, each described herein, the ethylene/alpha-olefin multi-block interpolymer (of component a) has a SS-Tm≥−40° C., or ≥−35° C., or ≥−30° C., or ≥−28° C., or ≥−25° C., or ≥−22° C., or ≥−20° C., or ≥−18° C., or ≥−17° C.

In one embodiment, or a combination of two or more embodiments, each described herein, the ethylene/alpha-olefin multi-block interpolymer (of component a) is an ethylene/alpha-olefin multi-block copolymer.

In one embodiment, or a combination of two or more embodiments, each described herein, the ethylene/alpha-olefin multi-block interpolymer (of component a) has a melt index (I2)≥0.2, or ≥0.3, or ≥0.4, or ≥0.5 g/10 min and/or ≤10, or ≤5.0, or ≤2.0, or ≤1.0, or ≤0.8 g/10 min.

In one embodiment, or a combination of two or more embodiments, each described herein, the ethylene/alpha-olefin multi-block interpolymer (of component a) has a molecular weight distribution (MWD=Mw/Mn)≥1.5, or ≥1.6, or ≥1.7, or ≥1.8, or ≥1.9, or ≥2.0 and/or ≤4.0, or ≤3.5, or ≤3.0, or ≤2.8, or ≤2.6, or ≤2.4.

In one embodiment, or a combination of two or more embodiments, each described herein, the propylene-based polymer (of component b) has a melt flow rate (MFR)≥1.0, or ≥2.0, or ≥3.0, or ≥3.5, or ≥4.0, or ≥4.5, or ≥5.0, or ≥5.5, or ≥6.0 g/10 min and/or ≤30, or ≤28, or ≤25, or ≤22, or ≤20, or ≤18, or ≤15, or ≤12, or ≤10, or ≤9.5, or ≤9.0, or ≤8.5, or ≤8.0, or ≤7.5 g/10 min.

In one embodiment, or a combination of two or more embodiments, each described herein, the propylene-based polymer (of component b) has a density≥0.860 g/cc, or ≥0.865 g/cc, or ≥0.870 g/cc, or ≥0.875 g/cc, or ≥0.880 g/cc, or ≥0.885 g/cc and/or ≤0.930 g/cc, or ≤0.925 g/cc, or ≤0.920 g/cc, or ≤0.915 g/cc, or ≤0.910 g/cc, or ≤0.905 g/cc, or ≤0.900 g/cc.

In one embodiment, or a combination of two or more embodiments, each described herein, the propylene-based polymer (of component b) is selected from a polypropylene homopolymer, a propylene/ethylene interpolymer or a propylene/alpha-olefin interpolymer, and further selected from a polypropylene homopolymer, a propylene/ethylene copolymer, or a propylene/alpha-olefin copolymer, and further selected from a polypropylene homopolymer, or a propylene/ethylene copolymer.

In one embodiment, or a combination of two or more embodiments, each described herein, the weight ratio of component a to component b is ≥5.0, or ≥5.5, or ≥26.0, or ≥6.5, or ≥7.0 and/or ≤40, or ≤38, or ≤36, or ≤35, or ≤34, or ≤33.

In one embodiment, or a combination of two or more embodiments, each described herein, the ratio of the MFR of component b to the I2 of component a is ≥4.0, or ≥6.0, or ≥8.0, or ≥10, or ≥12 and/or ≤25, or ≤22, or ≤20, or ≤18, or ≤16, or ≤15.

In one embodiment, or a combination of two or more embodiments, each described herein, the first composition comprises ≥88 wt %, or ≥89 wt %, or ≥90 wt % of component a, based on the sum weight of components a and b, and/or ≤97 wt %, or ≤96 wt %, or ≤95 wt % of component a, based on the sum weight of components a and b.

In one embodiment or a combination of two or more embodiments, each described herein, the first composition comprises ≥3.0 wt %, or ≥4.0 wt %, or ≥5.0 wt % of component b, based on the sum weight of components a and b, and/or ≤12 wt %, or ≤11 wt %, or ≤10 wt % of component b, based on the sum weight of components a and b.

In one embodiment, or a combination of two or more embodiments, each described herein, the first composition comprises ≥60 wt %, ≥70 wt %, or ≥80 wt %, or ≥85 wt % or ≥90 wt %, or ≥92 wt %, or ≥94, wt %, or ≥96 wt %, or ≥98 wt % of the sum of components a and b, based on the weight of the first composition. In one embodiment, or a combination of two or more embodiments, each described herein, the first composition comprises ≤100 wt %, or ≤99 wt %, of the sum of components a and b, based on the weight of the first composition.

In one embodiment, or a combination of two or more embodiments, each described herein, the composition further comprises at least one additive. In a further embodiment, the at least one additive is selected from fillers (for example, carbon black and talc), foaming agents (for example, AC and OBSH), antioxidants, colorants, processing aids (for example, zinc stearate), oils or any combination thereof.

In one embodiment, or a combination of two or more embodiments, each described herein, the composition has a “Bally Flex Failure Cycles”≥70 k, or ≥75 k, or ≥80 k, or ≥85 k, or ≥90 k, or ≥95 k, or ≥100 k, or ≥100 k.

In one embodiment, or a combination of two or more embodiments, each described herein, the composition has a Shore A Hardness≥20, or ≥30, or ≥40, or ≥50 and/or ≤70, or ≤69, or ≤68, or ≤67, or ≤66, or ≤65.

Also provided is an article comprising at least one component formed from the composition of an embodiment or a combination of two or more embodiments described herein. In a further embodiment, the article is artificial leather.

Also provided is a method of forming artificial leather, said method comprising mixing the composition of an embodiment or a combination of two or more embodiments described herein.

### Ethylene/Alpha-Olefin Multi-Bock Interpolymers

Ethylene/alpha-olefin multi-block interpolymers and copolymers. Such interpolymers and copolymers comprises, in polymerize form, ethylene, and an alpha-olefin. Alpha-olefins include, but are not limited to, a C3-C20 alpha-olefins, further C3-C10 alpha-olefins, further C3-C8 alpha-olefins, such as propylene, 1-butene, 1-pentene, 1-hexene, and 1-octene.

Ethylene/alpha-olefin multi-block interpolymers are characterized by multiple blocks or segments of two or more polymerized monomer units, differing in chemical or physical properties. In some embodiments, the multi-block copolymers can be represented by the following formula: (AB)n, where n is at least 1, preferably an integer greater than 1, such as 2, 3, 4, 5, 10, 15, 20, 30, 40, 50, 60, 70, 80, 90, 100, or higher. Here, “A” represents a hard block or segment, and “B” represents a soft block or segment. Preferably the A segments and the B segments are linked (or covalently bonded) in a substantially linear fashion, as opposed to a substantially branched or substantially star-shaped fashion. In other embodiments, the A segments and the B segments are randomly distributed along the polymer chain. In other words, for example, the block copolymers usually do not have a structure as follows: AAA-AA-BBB-BB. In still other embodiments, the block copolymers do not usually have a third type of block or segment, which comprises different comonomer(s). In yet other embodiments, each of block A and block B has monomers or comonomers substantially randomly distributed within the block. In other words, neither block A nor block B comprises two or more sub-segments (or sub-blocks) of distinct composition, such as a tip segment, which has a substantially different composition than the rest of the block.

The term “hard segments (HS),” as used herein, refer to blocks of polymerized monomer units, in which ethylene is present in an amount, for example, >90 mol %, or ≥92 mol %, or ≥95 mol %, or ≥98 mol %, or ≥99 mol %, based on the total number of moles of polymerized monomers in the blocks. In one embodiment, ethylene is present in an amount ≤99.8 mol %, or ≤99.6 mol %, or ≤99.4 mol %, or ≤99.3 mol %, based on the total number of moles of polymerized monomers in the blocks.

The term “soft segments (SS),” as used herein, refer to blocks of polymerized monomer units, in which ethylene is present in an amount, for example, ≤90 mol %, or ≤88 mol %, or ≤86 mol %, or ≤84 mol %, or ≤82 mol %, based on the total number of moles of polymerized monomers in the blocks. In one embodiment, ethylene is present in an amount ≥60 mol %, or ≥65 mol %, or ≥70 mol %, or ≥75 mol %, or ≥80 mol %, based on the total number of moles of polymerized monomers in the blocks.

The soft segments can be present in the ethylene/octene multi-block copolymer from 1 wt %, or 5 wt %, or 10 wt %, or 15 wt %, or 20 wt %, or 25 wt %, or 30 wt %, or 35 wt %, or 40 wt %, or 45 wt % to 55 wt %, or 60 wt %, or 65 wt %, or 70 wt %, or 75 wt %, or 80 wt %, or 85 wt %, or 90 wt %, or 95 wt %, or 99 wt % of the total weight of the ethylene/octene multi-block copolymer. Conversely, the hard segments can be present in similar ranges. The soft segment weight percentage and the hard segment weight percentage can be calculated based on data obtained from DSC or NMR. Such methods and calculations are disclosed in, for example, U.S. Pat. No. 7,608,668, the disclosure of which is incorporated by reference herein, in its entirety. For example, the hard segment and the soft segment weight percentages may be determined as described in column 57 to column 63 of U.S. Pat. No. 7,608,668, incorporated herein by reference.

Typically, ethylene comprises 50 mole percent or a majority mole percent of the whole multi-block interpolymer: that is, ethylene comprises at least 50 mole percent of the whole interpolymer. More preferably ethylene comprises at least 60 mole percent, or at least 70 mole percent, or at least 80 mole percent, or at least 90 mole percent, with the substantial remainder of the whole polymer comprising at least one other comonomer that is preferably an alpha-olefin having three or more carbon atoms.

As discussed, the ethylene/alpha-olefin multi-block interpolymers comprise two or more chemically distinct regions or segments (referred to as “blocks”), preferably joined in a linear manner. In an embodiment, the blocks differ in the amount or type of incorporated comonomer, density, amount of crystallinity, crystallite size attributable to a polymer of such composition, type or degree of tacticity (isotactic or syndiotactic), region-regularity or regio-irregularity, amount of branching (including long chain branching or hyper-branching), homogeneity or any other chemical or physical property. Compared to block interpolymers of the prior art, including interpolymers produced by sequential monomer addition, fluxional catalysts, or anionic polymerization techniques, the present ethylene/alpha-olefin multi-block interpolymer is characterized by unique distributions of both polymer polydispersity (PDI or Mw/Mn or MWD), polydisperse block length distribution, and/or polydisperse block number distribution, due, in an embodiment, to the effect of the shuttling agent(s) in combination with multiple catalysts used in their preparation.

The ethylene/alpha-olefin multi-block interpolymers, and further copolymers, in general, are produced via a chain shuttling process, such as, for example, described in U.S. Pat. No. 7,858,706, which is herein incorporated by reference. Some chain shuttling agents and related information are listed in column 16, line 39, through column 19, line 44. Some catalysts are described in column 19, line 45, through column 46, line 19, and some co-catalysts in column 46, line 20, through column 51 line 28. Some process features are described in column 51, line 29, through column 54, line 56. See also the following: U.S. Pat. Nos. 7,608,668; 7,893,166; and U.S. Pat. No. 7,947,793 as well as U.S. Pat. No. 8,476,393. See also U.S. Pat. No. 9,243,173.

In an embodiment, the ethylene/alpha-olefin multi-block copolymer (for example, an ethylene/octene multi-block copolymer) is produced in a continuous process and possesses a polydispersity index (Mw/Mn) from 1.7 to 3.5, or from 1.8 to 3, or from 1.8 to 2.5, or from 1.8 to 2.2. When produced in a batch or semi-batch process, the ethylene/alpha-olefin multi-block copolymer (for example, an ethylene/octene multi-block copolymer) typically possesses Mw/Mn from 1.0 to 3.5, or from 1.3 to 3, or from 1.4 to 2.5, or from 1.4 to 2.0.

In addition, the ethylene/alpha-olefin multi-block copolymer (for example, an ethylene/octene multi-block copolymer) typically possesses a PDI (or Mw/Mn) fitting a Schultz-Flory distribution rather than a Poisson distribution. In one embodiment, the ethylene/alpha-olefin multi-block copolymer (for example, an ethylene/octene multi-block copolymer) has both a polydisperse block distribution as well as a polydisperse distribution of block sizes. This results in the formation of polymer products having improved and distinguishable physical properties. The theoretical benefits of a polydisperse block distribution have been previously modeled and discussed in Potemkin, Physical Review E (1998) 57 (6), pp. 6902-6912, and Dobrynin, J. Chem. Phys. (1997) 107 (21), pp. 9234-9238. In an embodiment, the ethylene/alpha-olefin multi-block copolymer (for example, an ethylene/octene multi-block copolymer) possesses a most probable distribution of block lengths.

### Propylene-Based Polymers

Propylene-based interpolymers include polypropylene homopolymers, propylene/ethylene interpolymers and copolymers, and propylene/alpha-olefin interpolymers and copolymers. Alpha-olefins include, but are not limited to, a C4-C20 alpha-olefins, further C4-C10 alpha-olefins, further C4-C8 alpha-olefins, such as 1-butene, 1-pentene, 1-hexene, and 1-octene.

### Additives

An inventive composition may include one or more additives. Additives include, but are not limited to, fillers (for example, carbon black and talc), foaming agents (for example, AC and OBSH), antioxidants, colorants and processing aids (for example, zinc stearate). In an embodiment, the composition comprises at least one antioxidant. An antioxidant protects the composition from degradation caused by reaction with oxygen, induced by such things as heat, light, or residual catalyst present in a commercial material. Suitable antioxidants may include those commercially available from BASF, such as, IRGANOX 1010, IRGANOX B225, IRGANOX 1076 and IRGANOX 1726. These antioxidants, which act as radical scavengers, may be used alone, or in combination with other antioxidants, such as phosphite antioxidants, like IRGAFOS 168, also available from BASF. In an embodiment, the composition comprises from 0.01 wt %, or 0.02 wt %, or 0.04 wt %, or 0.06 wt %, or 0.08 wt %, or 0.10 wt %, or 0.20 wt % to 0.30 wt %, or 0.40 we %, or 0.50 wt %, or 0.60 wt %, or 0.80 wt % or 1.00 wt % of at least one antioxidant. Weight percent is based on total weight of the composition.

### Definitions

Unless stated to the contrary, implicit from the context, or customary in the art, all parts and percentages are based on weight, and all test methods are current as of the filing date of this disclosure.

The term “composition,” as used herein, includes a mixture of materials, which comprise the composition, as well as reaction products and decomposition products formed from the materials of the composition. Any reaction product or decomposition product is typically present in trace or residual amounts.

The term “polymer,” as used herein, refers to a polymeric compound prepared by polymerizing monomers, whether of the same or a different type. The generic term polymer thus includes the term homopolymer (employed to refer to polymers prepared from only one type of monomer, with the understanding that trace amounts of impurities can be incorporated into the polymer structure), and the term interpolymer as defined hereinafter. Trace amounts of impurities, such as catalyst residues, can be incorporated into and/or within the polymer. Typically, a polymer is stabilized with very low amounts (“ppm” amounts) of one or more stabilizers, such as one or more antioxidants.

The term “interpolymer,” as used herein, refers to a polymer prepared by the polymerization of at least two different types of monomers. The term interpolymer thus includes the term copolymer (employed to refer to polymers prepared from two different types of monomers) and polymers prepared from more than two different types of monomers.

The term “olefin-based polymer,” as used herein, refers to a polymer that comprises, in polymerized form, 50 wt % or a majority weight percent of an olefin, such as ethylene or propylene (based on the weight of the polymer), and optionally may comprise one or more comonomers.

The term “propylene-based polymer,” as used herein, refers to a polymer that comprises, in polymerized form, a majority weight percent of propylene (based on the weight of the polymer), and optionally may comprise one or more comonomers.

The term “ethylene-based polymer,” as used herein, refers to a polymer that comprises, in polymerized form, 50 wt % or a majority weight percent of ethylene (based on the weight of the polymer), and optionally may comprise one or more comonomers.

The term “ethylene/alpha-olefin interpolymer,” as used herein, refers to a interpolymer that comprises, in polymerized form, 50 wt % or a majority weight percent of ethylene (based on the weight of the interpolymer), and an alpha-olefin. The alpha-olefin is randomly distributed within the interpolymer. The term, “ethylene/alpha-olefin copolymer,” as used herein, refers to a copolymer that comprises, in polymerized form. 50 wt % or a majority amount of ethylene monomer (based on the weight of the copolymer), and an alpha-olefin, as the only two monomer types. The alpha-olefin is randomly distributed within the copolymer.

The term “ethylene/alpha-olefin multi-block interpolymer,” as used herein, refers to a multi-block interpolymer that comprises, in polymerized form, 45 wt %, and further 50 wt %, or a majority weight percent of ethylene (based on the weight of the interpolymer), and an alpha-olefin. The term “ethylene/alpha-olefin multi-block copolymer,” as used herein, refers to a multi-block copolymer that comprises, in polymerized form, 45 wt %, and further 50 wt %, or a majority weight percent of ethylene (based on the weight of the copolymer), and an alpha-olefin, as the only two monomer types. See also prior discussion.

The term “propylene/alpha-olefin interpolymer,” as used herein, refers to a interpolymer that comprises, in polymerized form, a majority weight percent of propylene (based on the weight of the interpolymer), and an alpha-olefin. The alpha-olefin is randomly distributed within the interpolymer. The term, “propylene/alpha-olefin copolymer.” as used herein, refers to a copolymer that comprises, in polymerized form, a majority amount of propylene monomer (based on the weight of the copolymer), and an alpha-olefin, as the only two monomer types. The alpha-olefin is randomly distributed within the copolymer.

The term “propylene/ethylene interpolymer,” as used herein, refers to a interpolymer that comprises, in polymerized form, a majority weight percent of propylene (based on the weight of the interpolymer), and ethylene. The ethylene is randomly distributed within the interpolymer. The term, “propylene/ethylene copolymer,” as used herein, refers to a copolymer that comprises, in polymerized form, a majority amount of propylene monomer (based on the weight of the copolymer), and ethylene, as the only two monomer types. The ethylene is randomly distributed within the copolymer.

The phrase “a majority weight percent,” as used herein, in reference to a polymer (or interpolymer or copolymer), refers to the amount of monomer present in the greatest amount in the polymer.

The terms “comprising,” “including,” “having,” and their derivatives, are not intended to exclude the presence of any additional component, step or procedure, whether the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure, not specifically delineated or listed.

### Listing of Some Composition Features

A] A composition comprising a first composition, and wherein the first composition comprises the following components a and b:
a) at least one ethylene/alpha-olefin multi-block interpolymer that comprises a density≤0.880 g/cc and a soft segment melting temperature (SS-Tm)≤2.0° C., further ≤1.0° C., further ≤0° C., further <0° C.;
b) at least one propylene-based polymer, and
   wherein component a is present in an amount ≥88 wt %, based on the sum weight of components a and b.
B] The composition of A] above, wherein the ethylene/alpha-olefin multi-block interpolymer (of component a) has a density≥0.855 g/cc, or ≥0.858 g/cc, or ≥0.860 g/cc, or ≥0.862 g/cc, or ≥0.864 g/cc, or ≥0.866 g/cc, or ≥0.868 g/cc, or ≥0.869 g/cc.
C] The composition of A] or B] above, wherein the ethylene/alpha-olefin multi-block interpolymer (of component a) has a density≤0.880 g/cc, or ≤0.878 g/cc, or ≤0.876 g/cc, or ≤0.874 g/cc, or ≤0.872 g/cc, or ≤0.871 g/cc, or ≤0.870 g/cc.
D] The composition of any one of A]-C](A] through C]) above, wherein the ethylene/alpha-olefin multi-block interpolymer (of component a) has a SS-Tm≤2.0° C., or ≤1.5° C., or ≤1.0° C., or ≤0.8° C., or ≤0.6° C., or ≤0.4° C. or ≤0.2° C., or ≤0.1° C., or ≤0.0° C., or ≤−0.5° C., or ≤−1.0° C., or ≤−2.0° C., or ≤−5.0° C., or ≤−8.0° C.
E] The composition of any one of A]-D]above, wherein the ethylene/alpha-olefin multi-block interpolymer (of component a) has a SS-Tm≥−40° C., or ≥−35° C., or ≥−30° C., or ≥−28° C., or ≥−25° C., or ≥−22° C., or ≥−20° C., or ≥−18° C., or ≥−17° C.
F] The composition of any one of A]-E]above, wherein component a has a density≥0.855 g/cc, or ≤0.858 g/cc, or ≥0.860 g/cc, or ≥0.862 g/cc, or ≥0.864 g/cc, or ≥0.866 g/cc, or ≥0.868 g/cc, or ≥0.869 g/cc.
G] The composition of any one of A]-F]above, wherein component a has a density≤0.878 g/cc, or ≤0.876 g/cc, or ≤0.874 g/cc, or ≤0.872 g/cc, or ≤0.871 g/cc, or ≤0.870 g/cc.
H] The composition of any one of A]-G]above, wherein component a has a SS-Tm≤2.0° C., or ≤1.5° C., or ≤1.0° C., or ≤0.8° C., or ≤0.6° C., or ≤0.4° C., or ≤0.2° C., or ≤0.1° C., or ≤0.0° C., or ≤−0.5° C., or ≤−1.0° C., or ≤−2.0° C., or ≤−5.0° C., or ≤−8.0° C.
I] The composition of any one of A]-H]above, wherein component a has a SS-Tm≥−40° C., or ≥−35° C., or ≥−30° C., or ≥−28° C., or ≥−25° C., or ≥−22° C., or ≥−20° C., or ≥−18° C., or ≥−17° C.
J] The composition of any one of A]-I] above, wherein the ethylene/alpha-olefin multi-block interpolymer (of component a) is an ethylene/alpha-olefin multi-block copolymer.
K] The composition of any one of A]-J]above, wherein the alpha-olefin of the ethylene/alpha-olefin multi-block interpolymer, and further copolymer, is a C3-C20 alpha-olefin, and further a C3-C10 alpha-olefin, and further a C₃-C₈ alpha-olefin.
L] The composition of any one of A]-K]above, wherein the alpha-olefin of the ethylene/alpha-olefin multi-block interpolymer, and further copolymer, is selected from propylene, 1-butene, 1-pentene, 1-hexene or 1-octene, and further propylene, 1-butene or 1-octene, and further propylene or 1-octene, and further 1-octene.
M] The composition any one of A]-L]above, wherein the ethylene/alpha-olefin multi-block interpolymer (of component a) has a melt index (I2)≥0.2, or ≥0.3, or ≥0.4, or ≥0.5 g/10 min and/or ≤10, or ≤5.0, or ≤2.0, or ≤1.0, or ≤0.8 g/10 min.
N] The composition of any one of A]-M]above, wherein the ethylene/alpha-olefin multi-block interpolymer (of component a) has a molecular weight distribution (MWD=Mw/Mn)≥1.5, or ≥1.6, or ≥1.7, or ≥1.8, or ≥1.9, or ≥2.0 and/or ≤4.0, or ≤3.5, or ≤3.0, or ≤2.8, or ≤2.6, or ≤2.4.
O] The composition of any one of A]-N]above, wherein the ethylene/alpha-olefin multi-block interpolymer (of component a) has a number average molecular weight (Mn) 10,000 g/mol, or ≥15,000 g/mol, or ≥20.000 g/mol, or ≥25,000 g/mol, or ≥30,000 g/mol, or ≥32.000 g/mol, or ≥35,000 g/mol and/or S 100,000 g/mol, or ≤90,000 g/mol, or ≤80,000 g/mol, or ≤75,000 g/mol, or ≤70,000 g/mol, or ≤65,000 g/mol, or ≤60,000 g/mol.
P] The composition of any one of A]-O]above, wherein the ethylene/alpha-olefin multi-block interpolymer (of component a) has melting temperature (Tₘ)≥90° C., or ≥100° C., or ≥105° C., or ≥110° C., or ≥112° C., or ≥114° C., or ≥116° C., or ≥118° C. and/or ≤140° C., or ≤135° C., or ≤130° C., or ≤128° C., or ≤126° C., or ≤124° C., or ≤122° C.

Q] The composition of any one of A]-P]above, wherein the ethylene/alpha-olefin multi-block interpolymer (of component a) has a glass transition temperature (Tg)≥−75.0° C., or ≥−72.0° C., or ≥−70.0° C., or ≥−68.0° C., or ≥−66.0° C., or ≥−65.0° C., as determined by DSC and/or ≤−50.0° C., or ≤−55.0° C., or ≤−60.0° C., as determined by DSC.
R] The composition of any one of A]-Q]above, wherein component a comprises only one ethylene/alpha-olefin multi-block interpolymer, and further one ethylene/alpha-olefin multi-block copolymer.
S] The composition of any one of A]-R]above, wherein the propylene-based polymer (of component b) has a melt flow rate (MFR)≥1.0, or ≥2.0, or ≥3.0, or ≥3.5, or ≥4.0, or ≥4.5, or ≥5.0, or ≥5.5, or ≥6.0 g/10 min and/or ≤30, or ≤28, or ≤25, or ≤22, or ≤20, or ≤18, or ≤15, or ≤12, or ≤10, or ≤9.5, or ≤9.0, or ≤8.5, or ≤8.0, or ≤7.5 g/10 min.
T] The composition of any one of A]-S]above, wherein the propylene-based polymer (of component b) has a density≥0.860 g/cc, or ≥0.865 g/cc, or 0.870 g/cc, or 0.875 g/cc, or ≥0.880 g/cc, or ≥0.885 g/cc and/or ≤0.930 g/cc, or ≤0.925 g/cc, or ≤0.920 g/cc, or ≤ 0.915 g/cc, or ≤0.910 g/cc, or ≤0.905 g/cc, or ≤0.900 g/cc.
U] The composition of any one of A]-T]above, wherein component b has a melt flow rate (MFR)≥1.0, or ≥2.0, or ≥3.0, or ≥3.5, or ≥4.0, or ≥4.5, or ≥5.0, or ≥5.5, or ≥6.0 g/10 min and/or ≤30, or ≤28, or ≤25, or ≤22, or ≤20, or ≤18, or ≤15, or ≤12, or ≤10, or ≤9.5, or ≤9.0, or ≤8.5, or ≤8.0, or ≤7.5 g/10 min.
V] The composition of any one of A]-U]above, wherein component b has a density≥0.860 g/cc, or ≥0.865 g/cc, or ≥0.870 g/cc, or ≥0.875 g/cc, or ≥0.880 g/cc, or ≥0.885 g/cc and/or ≤0.930 g/cc, or ≤0.925 g/cc, or ≤0.920 g/cc, or ≤0.915 g/cc, or ≤0.910 g/cc, or ≤0.905 g/cc, or ≤0.900 g/cc.
W] The composition of any one of A]-V]above, wherein the propylene-based polymer (of component b) is selected from a polypropylene homopolymer, a propylene/ethylene interpolymer or a propylene/alpha-olefin interpolymer, and further selected from a polypropylene homopolymer, a propylene/ethylene copolymer, or a propylene/alpha-olefin copolymer and further selected from a polypropylene homopolymer, or a propylene/ethylene copolymer.
X] The composition of W] above, wherein the alpha-olefin of the propylene/alpha-olefin interpolymer, and further copolymer, is a C4-C20 alpha-olefin, and further a C4-C10 alpha-olefin, and further a C4-C8 alpha-olefin.
Y] The composition of W] or X] above, wherein the alpha-olefin of the propylene/alpha-olefin interpolymer, and further copolymer, is selected from 1-butene, 1-pentene, 1-hexene or 1-octene, and further 1-butene or 1-octene, and further 1-octene.
Z] The composition of any one of A]-Y]above, wherein component b comprises only one propylene-based polymer, further one propylene-based polymer selected from a polypropylene homopolymer, a propylene/ethylene interpolymer or a propylene/alpha-olefin interpolymer, and further selected from a polypropylene homopolymer, a propylene/ethylene copolymer, or a propylene/alpha-olefin copolymer, and further selected from a polypropylene homopolymer, or a propylene/ethylene copolymer.
A2] The composition of any one of A]-Z]above, wherein the weight ratio of component a to component b is ≥5.0, or ≥5.5, or ≥6.0, or ≥6.5, or ≥7.0 and/or ≤40, or ≤38, or ≤36, or ≤35, or ≤34, or ≤33.
B2] The composition of any one of A]-A2] above, wherein the ratio of the MFR of component b to the I2 of component a is ≥4.0, or ≥6.0, or ≥8.0, or ≥10, or ≥12 and/or ≤25, or ≤22, or ≤20, or ≤18, or ≤16, or ≤15.
C2] The composition of any one of A]-B2] above, wherein the ratio of the density of component b to the density of component a is ≥0.800, or ≥0.850, or ≥0.900, or ≥0.950, or ≥1.00 and/or ≤1.30, or ≤1.25, or ≤1.20, or ≤1.15, or ≤1.10, or ≤1.05.
D2] The composition of any one of A]-C2] above, wherein the first composition comprises ≥88 wt %, or ≥89 wt %, or ≥90 wt % of component a and/or ≤97 wt %, or ≤96 wt %, or ≤95 wt % of component a, based on the sum weight of components a and b.
E2] The composition of any one of A]-D2] above, wherein the first composition comprises ≥3.0 wt %, or ≥4.0 wt %, or ≥5.0 wt % of component b and/or ≤12 wt %, or ≤11 wt %, or ≤10 wt % of component b, based on the sum weight of components a and b.
F2] The composition of any one of A]-E2] above, wherein the first composition comprises ≥60 wt %, ≥70 wt %, or ≥80 wt %, or ≥85 wt %, or ≥90 wt %, or ≥92 wt %, or ≥94 wt %, or ≥96 wt %, or ≥98 wt %/e of the sum of components a and b, based on the weight of the first composition.
G2] The composition of any one of A]-F2] above, wherein the first composition comprises ≤100 wt %, or ≤99 wt % of the sum of components a and b, based on the weight of the first composition.
H2] The composition of any one of A]-G2] above, wherein the first composition comprises components a and b as the only polymer components of the first composition.
I2] The composition of any one of A]-H2] above, wherein the composition comprises ≥89 wt %, or ≥90 wt % of component a, based on the weight of the composition, and/or ≤97 wt %, or ≤96 wt %, or ≤95 wt % of component a, based on the weight of the composition.
J2] The composition of any one of A]-I2] above, wherein the composition comprises ≥3.0 wt %, or ≥4.0 wt %, or ≥5.0 wt % of component b, based on the weight of the composition, and/or ≤12 wt %, or ≤11 wt %, or ≤10 wt % of component b, based on the weight of the composition.
K2] The composition of any one of A]-J2] above, wherein the composition comprises ≥50 wt %, or ≥60 wt %, ≥70 wt %, or ≥80 wt %, or ≥85 wt %, or ≥90 wt %, or ≥92 wt %, or ≥94 wt %, or ≥96 wt % of the sum of components a and b, based on the weight of the composition, and/or ≤100 wt %, or ≤99 wt %, ≤98 wt %, or ≤97 wt % of the sum of components a and b, based on the weight of the composition.
L2] The composition of any one of A]-K2] above, wherein the composition comprises ≥50 wt %, or ≥60 wt %, ≥70 wt %, or ≥80 wt %, or ≥85 wt %, or ≥90 wt %, or ≥95 wt %, or ≥96 wt %, or ≥97 wt % of the first composition, based on the weight of the composition, and/or ≤100 wt %, or ≤99 wt %, ≤98 wt % of the first composition, based on the weight of the composition.
M2] The composition of any one of A]-L2] above, wherein the composition further comprises at least one additive.
N2 The composition of M2] above, wherein the at least one additive is selected from fillers (for example, carbon black and talc), foaming agents (for example, AC and OBSH), antioxidants, colorants, processing aids (for example, zinc stearate), oils or any combination thereof.
O2] The composition of M2] or N2] above, wherein the composition further comprises at least one filler.
P2] The composition of O2] above, wherein the composition comprises ≥0.5 wt %, or 1.0 wt %, or ≥2.0 wt %, or ≥5.0 wt %, or ≥10 wt % M of the at least one filler and/or ≤40 wt %, or ≤35 wt %, or ≤30 wt %, or ≤25 wt %, or ≤20 wt % of the at least one filler, based on the weight of the composition.
Q2] The composition of M2] or N2] above, wherein the at least one additive is present in an amount ≥0.01 wt %, or ≥0.02 wt %, or ≥0.05 wt %, or ≥0.10 wt %, or ≥0.20 wt %, or ≥0.50 wt % and/or ≤10 wt %, or ≤5.0 wt %, or ≤2.0 wt %, or ≤1.0 wt %, based on the weight of the composition.
R2] The composition of any one of A]-Q2] above, wherein the composition further comprises a polymer, different from each of component a and component b, independently, in one or more features, such as monomer types, monomer distributions, monomer amounts, density, melt index (I2) or melt flow rate (MFR), Mn, MWD, or any combination thereof, and further in one or more features, such as monomer types, monomer distributions, monomer amounts, density, melt index (I2) or melt flow rate (MFR), or any combination thereof.
S2] The composition of any one of A]-R2] above, wherein the composition comprises ≤5.0 wt %, or ≤2.0 wt %, or ≤1.0 wt %, or ≤0.5 wt %, or ≤0.2 wt %, or ≤0.1 wt %, or ≤0.05 wt % of an amide compound (for example, a fatty amide), based on the weight of the composition; and further the composition does not comprise an amide compound.
T2] The composition of any one of A]-S2] above, wherein the composition comprises ≤5.0 wt %, or ≤2.0 wt %, or ≤1.0 wt %, or ≤0.5 wt %, or ≤0.2 wt %, or ≤0.1 wt %, or ≤0.05 wt % of a polyamide, based on the weight of the composition; and further the composition does not comprise a polyamide.
U2] The composition of any one of A]-T2] above, wherein the composition comprises ≤ 5.0 wt %, or ≤2.0 wt %, or ≤1.0 wt %, or ≤0.5 wt %, or ≤0.2 wt %, or ≤0.1 wt %, or ≤0.05 wt % of an ethylene vinyl acetate (EVA) polymer, based on the weight of the composition; and further the composition does not comprise an ethylene vinyl acetate (EVA) polymer.
V2] The composition of any one of A]-U2] above, wherein the composition comprises ≤5.0 wt %, or ≤2.0 wt %, or ≤1.0 wt %, or ≤0.5 wt %, or ≤0.2 wt %, or ≤0.1 wt %, or ≤0.05 wt % of a metal hydroxide (for example, magnesium hydroxide), based on the weight of the composition; and further the composition does not comprise a metal hydroxide.
W2] The composition of any one of A]-V2] above, wherein the composition comprises ≤5.0 wt %, or ≤2.0 wt %, or ≤1.0 wt %, or ≤0.5 wt % or ≤0.2 wt %, or ≤0.1 wt %, or ≤0.05 wt % of a wax, based on the weight of the composition; and further the composition does not comprise a wax.
X2] The composition of any one of A]-W2] above, wherein the composition comprises ≤5.0 wt %, or ≤2.0 wt %, or ≤1.0 wt %, or ≤0.5 wt %, or ≤0.2 wt %, or ≤0.1 wt % or ≤0.05 wt % of a tackifier, based on the weight of the composition; and further the composition does not comprise a tackifier.
Y2] The composition of any one of A]-X2] above, wherein the composition has a “Bally Flex Failure Cycles”≥70 k, or ≥75 k, or ≥80 k, or ≥85 k, or ≥90 k, or ≥95 k, or ≥100 k, or ≥100 k. Bally Flex is determined as described herein.
Z2] The composition of any one of A]-Y2] above, wherein the composition has a Shore A Hardness≥20, or ≥30, or ≥40, or ≥50 and/or ≤70, or ≤69, or ≤68, or ≤67, or ≤66, or ≤65. Shore A Hardness is determined as described herein.
A3] An article comprising at least one component formed from the composition of any one of A]-Z2] above.
B3] The article of A3] above, wherein the article is artificial leather.
C3]A method of forming artificial leather, said method comprising mixing the composition of any one of A]-Z2] above.
D3] The method of C3] above, wherein the method further comprises thermally treating the composition.
E3] The method of D3] above, wherein the composition is thermally treated at a temperature≥80° C., or ≥90° C., or ≥100° C., or ≥110° C., or ≥120° C., or 130° C., or 140° C. and/or ≤200° C., or ≤190° C., or ≤180° C., or ≤170° C. or ≤165° C., or ≤160° C.

### Test Methods

### Melt Index or Melt Flow Rate of a Polymer

The melt index MI (or 12) of an ethylene-based polymer is measured in accordance with ASTM D-1238, condition 190° C./2.16 kg. The melt flow rate MFR of a propylene-based polymer is measured in accordance with ASTM D-1238, condition 230° C./2.16 kg.

### Density

The density of a polymer is measured in accordance with ASTM D792, Method B. The result is recorded in grams per cubic centimeter (g/cc=g/cm³).

### Bally FRex Test

The Bally Flex test was used to evaluate resistance to cracking of the thin (1.1 nun) plaques prepared from the inventive and comparative compositions. The Bally Flex test determines the durability of synthetic leather and fabrics, by repeatedly flexing the test specimen. Here, each plaque was subjected to repeated flexing. The test conformed to ASTM D6182-00 at room temperature (23° C.). The Bally Flexometer conformed to DIN 53351, and operated at a rate of 100 cycles/min. The end of the test was determined by the number of cycles, at which cracking of the plaque's front surface was observed, and was reported as the Bally Flex result. Results are reported in the number of cycles. Two specimens were tested for each composition, and the average value was reported. If no crack/damage was observed after 100,000 cycles for the two specimens, the result was reported as “greater than 100,000 or >100 k.”

### Shore A Hardness

Shore A hardness was measured in accordance with ASTM D2240. The load was 0.5 kg, and the duration time was five seconds. Two, “3 mm thick” plaques were stacked together for the test. Five test samples tested per composition, and an average reported.

### Differential Scanning Calorimetry (DSC) for Ethylene/Alpha-Olefin Multi-Block Interpolymers and Determination of SS-Tin

Differential Scanning Calorimetry (DSC) can be used to measure the melting, crystallization, and glass transition behavior of a polymer over a wide range of temperature. For example, the TA Instruments Discovery DSC, equipped with an RCS (refrigerated cooling system) and an autosampler, is used to perform this analysis. During testing, a nitrogen purge gas flow of 50 m/min is used. Each sample is melt pressed (preheated for 2 minutes, and pressed at a pressure of 10 MPa for 2 minutes) into a thin film, at about 190° C. The melted sample is then air-cooled to room temperature (about 25° C.). A “3-10 mg,” 6 mm diameter specimen is extracted from the cooled polymer, weighed, placed in a light aluminum pan (about 50 mg), and crimped shut. Analysis is then performed to determine its thermal properties.

The thermal behavior of the sample is determined by ramping the sample temperature up and down to create “beat flow versus temperature” profiles. First, the sample is rapidly heated to 180° C., and held isothermally for 5 minutes, in order to remove its thermal history. Next, the sample is cooled to −90° C., at a 10° C./minute cooling rate, and held isothermally at −90° C. for 5 minutes. The sample is then heated to 150° C. (this is the “second heat” ramp) at a 10° C./minute heating rate. The cooling and second heating curves are recorded.

The soft segment melting temperature (SS-Tm) is determined from the DSC second heating curve. For example, an ethylene/octene multi-block copolymer typically has two melting peaks, one melting peak associated with the soft segments and one melting point associated with the hard segments. The SS-Tm is associated with the lower temperature peak for the soft segments. For some block copolymers, the peak associated with the melting of the soft segments is a small hump (or bump) over the baseline, making it difficult to assign a peak maximum. This difficulty can be overcome by converting a normal DSC profile into a weighted DSC profile using the following method.

In DSC, the heat flow depends on the amount of the material melting at a certain temperature, as well as on the temperature-dependent specific heat capacity. The temperature dependence of the specific heat capacity, in the melting regime, of linear low-density polyethylene leads to an increase in the heat of fusion with decreasing comonomer content. That is, the heat of fusion values get progressively lower as the crystallinity is reduced with increasing comonomer content. See Wild, L. Chang, S.; Shankernarayanan, M J., Improved Method for Compositional Analysis of Polyolefins by DSC, Polym. Prep 1990; 31: 270-1, which is incorporated by reference herein in its entirety. For a given point in the DSC curve (defined by its heat flow in watts per gram(W/g) and temperature in degrees Celsius), by taking the ratio of “the temperature-dependent heat of fusion (ΔH (T))” to “the heat of fusion expected for a linear copolymer.” the DSC curve can be converted into a weight-dependent distribution curve, as discussed below.

For a DSC analysis of a composition, the second heating curve is baseline corrected, for example, by drawing a linear baseline between the heat flow at −50° C. and 135° C. The temperature-dependent heat of fusion curve (or “Enthalpy (J/g) versus Temperature (° C.)”) can then be generated from the summation of the integrated heat flow between two consecutive data points (from the “Heat Flow (Wig) versus Time (min)” profile). This summation is represented overall by a cumulative enthalpy curve (“Enthalpy (J/g) versus Temperature (° C.)” profile). Note, Joule (J)=Watt (W)*sec, and each temperature is determined from the respective time point and the temperature ramp.

The expected relationship between the heat of fusion for linear ethylene/octene copolymers, at a given temperature, is shown by the “heat of fusion versus melting temperature” curve. Using random ethylene/octene copolymers, one can obtain the following relationship (calibration equation) for the expected heat of fusion of linear copolymers, ΔH_{linear copolymer}, and melting temperature, Tm (in ° C.):

$$Δ {H}_{linear copolymer} ( J / g ) = 0.0072 * {T}_{m}^{2} + 0.3138 * {T}_{m} + 8.9767 .$$

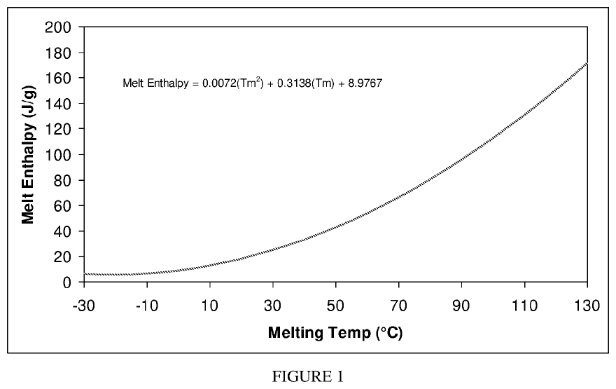

See also FIG. 1 (“Melt Enthalpy (J/g) versus Temperature (° C.)” for linear copolymers).

For each integrated data point from the cumulative enthalpy curve (“Enthalpy (J/g) versus Temperature (° C.)” profile), at a given temperature (T), the ratio of ‘the enthalpy from the cumulative enthalpy curve” to the expected heat of fusion for linear copolymers at that temperature,” yields a fractional weight that can be assigned to the respective data point. Thus, DSC Wt. Fraction=[Cumulative Enthalpy (at T)/Melt Enthalpy (at T) from the calibration equation]. Using this ratio, a plot of the DSC Wt. Fraction versus Temperature (C) can be generated, and the area under this curve (or A_{Total}) can be calculated.

A normalized DSC Wt. Fraction, at each T, can be calculated by dividing the value for the DSC Wt. Fraction by Amr (or DSC Wt. Fraction/A_{Total}). Thus, a normalized DSC Wt. Fraction versus Temperature (° C.) curve can be generated. The soft segment Tm (SS-Tm) is assigned as temperature at the location of the maximum in the normalized DSC Wt. Fraction versus Temperature (° C.) curve. The method is applicable to ethylene/octene copolymers but can be adapted to other polymers as well.

The glass transition temperature, Tg, is determined from the DSC second heating curve, where half the sample has gained the liquid heat capacity as described in Bernhard Wunderlich, The Basis of Thermal Analysis, in Thermal Characterization of Polymeric Materials, 92, 278-279 (Edith A. Turi ed., 2d ed. 1997). Baselines are drawn from below and above the glass transition region and extrapolated through the Tg region. The temperature at which the sample heat capacity is half-way between these baselines is the Tg. Melting point, Tm, of the polymer is determined as the temperature corresponding to the maximum heat flow in the DSC heating curve.

### Gel Permeation Chromatography (GPC)—Ethylene-Based Polymers

The chromatographic system consists of a PolymerChar GPC-IR (Valencia, Spain) high temperature GPC chromatograph, equipped with an internal IR5 infra-red detector (IR5). The autosampler oven compartment is set at 160 Celsius, and the column compartment is set at 150 Celsius. The columns are four AGILENT “Mixed A” 30 cm, 20-micron linear mixed-bed columns. The chromatographic solvent is 1,2,4-trichlorobenzene, which contained 200 ppm of butylated hydroxytoluene (BHT). The solvent source is nitrogen sparged. The injection volume is 200 microliters, and the flow rate is 1.0 milliliters/minute.

Calibration of the GPC column set is performed with 21 narrow molecular weight distribution polystyrene standards, with molecular weights ranging from 580 to 8,400,000, and which are arranged in six “cocktail” mixtures, with at least a decade of separation between individual molecular weights. The standards are purchased from Agilent Technologies. The polystyrene standards are prepared at “0.025 grams in 50 milliliters” of solvent, for molecular weights equal to, or greater than, 1,000,000, and at “0.05 grams in 50 milliliters” of solvent, for molecular weights less than 1,000,000. The polystyrene standards are dissolved at 80° Celsius, with gentle agitation, for 30 minutes. The polystyrene standard peak molecular weights are converted to polyethylene molecular weights using Equation 1 (as described in Williams and Ward, J. Polym. Sci. Polym. Let., 6, 621 (1968)):

$${M}_{polyethylene} = A \times {( {M}_{polystyrene} )}^{B} , \qquad ( EQ1 )$$

where M is the molecular weight, A has a value of 0.4315 and B is equal to 1.0.

A fifth order polynomial is used to fit the respective polyethylene equivalent calibration points. A small adjustment to A (from approximately 0.375 to 0.445) is made to correct for column resolution and band-broadening effects, such that linear homopolymer polyethylene standard is obtained at 120.000 Mw.

The total plate count of the GPC column set is performed with decane (prepared at “0.04 g in 50 milliliters” of TCB, and dissolved for 20 minutes with gentle agitation). The plate count (Equation 2) and symmetry (Equation 3) are measured on a 200 microliter injection according to the following equations:

$$Plate Count = 5.54 * {( \frac{( {RV}_{PEAKMax}}{Peak Width at \frac{1}{2} height} )}^{2} , \qquad ( EQ2 )$$

where RV is the retention volume in milliliters, the peak width is in milliliters, the peak max is the maximum height of the peak, and ½ height is ½ height of the peak maximum; and

$$Symmetry = \frac{( Rear Peak {RV}_{one tenth height} - {RV}_{Peak max} )}{{RV}_{Peak max} - Front Peak {RV}_{one tenth height} )} , \qquad ( EQ3 )$$

where RV is the retention volume in milliliters, and the peak width is in milliliters, Peak max is the maximum position of the peak, one tenth height is i/10 height of the peak maximum, and where rear peak refers to the peak tail at later retention volumes than the peak max, and where font peak refers to the peak front at earlier retention volumes than the peak max. The plate count for the chromatographic system should be greater than 18,000, and symmetry should be between 0.98 and 1.22.

Samples are prepared in a semi-automatic manner with the PolymerChar “Instrument Control” Software, wherein the samples are weight-targeted at “2 mg/ml,” and the solvent (contained 200 ppm BHT) is added to a pre nitrogen-sparged, septa-capped vial, via the PolymerChar high temperature autosampler. The samples are dissolved for two hours at 160° Celsius under “low speed” shaking.

The calculations of Mn(GPC), Mw(GPC), and Mz(GPC) are based on GPC results using the internal IR5 detector (measurement channel) of the PolymerChar GPC-IR chromatograph according to Equations 4-6, the PolymerChar GPCOne™ software, the baseline-subtracted IR chromatogram at each equally-spaced data collection point (i), and the polyethylene equivalent molecular weight obtained from the narrow standard calibration curve for the point (i) from Equation 1. Equations 4-6 are as follows:

$$Mn ( GPC ) = \frac{{\sum }^{i} {IR}_{i}}{{\sum }^{i} ( {IR}_{i} / {M}_{{polyethyee}_{i}} )} , \qquad ( EQ4 )$$

$$Mw ( GPC ) = \frac{{\sum }^{i} ( {IR}_{i} * {M}_{{polyethyee}_{i}} )}{{\sum }^{i} {IR}_{i}} , and \qquad ( EQ5 )$$

$$Mz ( GPC ) = \frac{{\sum }^{i} ( {IR}_{i} * {M}_{{polyethyee}_{i}^{2}} )}{{\sum }^{i} ( {IR}_{i} * {M}_{{polyethyee}_{i}} )} . \qquad ( EQ6 )$$

In order to monitor the deviations over time, a flowrate marker (decane) is introduced into each sample, via a micropump controlled with the PolymerChar GPC-IR system. This flowrate marker (FM) is used to linearly correct the pump flowrate (Flowrate(nominal)) for each sample, by RV alignment of the respective decane peak within the sample (RV(FM Sample)), to that of the decane peak within the narrow standards calibration (RV(FM Calibrated)). Any changes in the time of the decane marker peak are then assumed to be related to a linear-shift in flowrate (Flowrate(effective)) for the entire nm. To facilitate the highest accuracy of a RV measurement of the flow marker peak, a least-squares fitting routine is used to fit the peak of the flow marker concentration chromatogram to a quadratic equation. The first derivative of the quadratic equation is then used to solve for the true peak position. After calibrating the system, based on a flow marker peak, the effective flowrate (with respect to the narrow standards calibration) is calculated from Equation 7:

$$Flowrate ( effective ) = Flowrate ( nominal ) * ( RV ( FM Calibrated ) / RV ( FM Sample ) ) . \qquad ( EQ7 )$$

Processing of the flow marker peak is done via the PolymerChar GPCOne™ software. Acceptable flowrate correction is such that the effective flowrate should be within +/−0.7% of the nominal flowrate.

### Experimental

Polymers are shown in Table 1 and compositions are shown in Table 2.

TABLE 1
Polymers for Blending

| | | SS-Tm |
|---|---|---|
| Product Name | Chemical Description | (° C.) |
| INFUSE 9077 Olefin Block | Ethylene/octene multi-block copolymer, density 0.869 g/cc, | −15 to −17 |
| Copolymer | MI (or I2) = 0.5 g/10 min (190° C./2.16 kg), | |
| | Shore A = 51, available from The Dow Chemical Company | |
| RCP FCP80 | Random copolymer (propylene/ethylene) | NA |
| (propylene-based polymer) | MFR = 7.5 g/10 min (230° C./2.16 kg) | |
| | Density = 0.9 g/cc, available from SK, Wuhan | |
| Homo PP 9006 | Polypropylene, | NA |
| | MFR = 6.0 g/10 min (230° C./2.16 kg) | |
| | Density 0.9 g/cc, available from Sinopec Maoming | |
| INFUSE 9007 Olefin Block | Ethylene/octene multi-block copolymer, density = 0.866 g/cc, | 8 |
| Copolymer | MI = 0.5 g/10 min (190° C./2.16 kg), | |
| | Shore A = 64, available from The Dow Chemical Company | |
| INFUSE 9107 Olefin Block | Ethylene/octene multi-block copolymer, density = 0.866 g/cc, | 9 |
| Copolymer | MI = 1 g/10 min (190° C./2.16 kg), | |
| | Shore A = 60-61, available from The Dow Chemical Company | |
| ENGAGE 8200 Polyolefin | Ethylene/octene copolymer, | NA |
| Elastomer | density = 0.87 g/cc, MI = 5 g/10 min (190° C./2.16 kg), | |
| | Shore A = 66, available from The Dow Chemical Company | |
| ENGAGE 8842 Polyolefin | Ethylene/octene copolymer, | NA |
| Elastomer | Density = 0.857 g/cc, MI = 1 g/10 min (190° C./2.16 kg), Shore | |
| | A = 54, available from The Dow Chemical Company | |

NA = Not Applicable.
Note, the SS-Tm values for the following: INFUSE 9000 = 9° C.; INFUSE 9100 = 3° C.; INFUSE
9500 = 4° C.; INFUSE 9507 = 7° C.; INFUSE 9530 = 6° C.; INFUSE 9010 = 28° C.

### Brabender Miring and Compression Molding

For each composition shown in Table 2, the noted polymers (approx. 260 g of pellets) were fed into a “350 ml chamber” of a Brabender mixer, at a set temperature of 180° C., with a rotor speed of 30 rpm. After around two minutes, the rotor speed was increased to 50 rpm. The mixing was continued at 50 rpm for another six minutes. The compound (gum) was collected and pressed into a flat pie shape for the following tests.

The composition (pie shaped gum) from the Brabender mixer was compression molded into a plaque in a “1.0 mm” thick mold. The compound (approx. 11 g) was preheated at 180° C. for five minutes, and then degassed (repeated compression at 10 MPa and release, for six times), followed by another two minutes at a pressure of 10 MPa and a temperature of 180° C. The plaques (dimensions: 15 cm×7 cm×1.1 mm) were taken out from the mold, after ramping the mold temperature down to room temperature. The obtained plaques were further cut (die cut) into the required shape and size of “38 mm×63 mm×1.1 mm” for the for Bally Flex test. Results from the Bally Flex test are shown in Table 2.

For the Shore A Hardness test, for each composition, a “3.0 mm thick” plaque was compression molded (molding conditions: 180° C., 10 MPa, 3 minutes) from about 30 grams of the composition (pie shaped gum), to provide a plaque with dimensions: 100 mm×100 mm×3.0 mm. Shore A Hardness results are shown in Table 2.

### Results

As seen in Table 2, it was discovered that the inventive compositions (IE1, IE2, IE3) each provide a high Bally Flex resistance, as seen by the high Bally Flex failure cycle number, and provide a good softness, as seen by a relatively low Shore A number. These properties are needed for artificial leather.

The inventive compositions in Table 2 demonstrated that a small amount (5%, 10%) of the propylene-based polymer (RCP, h-PP) can significantly enhance the Bally Flex resistance from 20 k (see CS1) to 100 k or more (see IE1-IE3). The Bally Flex failure cycle values of the inventive compositions are much better than the comparative compositions containing OBC grades with a similar hardness (for example, INFUSE 9107, 61A (CS9), Bally Flex failure cycles 20 k; INFUSE 9007, 64A (CS10), Bally Flex failure cycles 61 k). This comparison proves the usefulness of the inventive compositions, each modified with a small amount of a propylene-based polymer. Also, since the melting point of the propylene-based polymer is typically higher than that of the ethylene/alpha-olefin multi-block interpolymer, the addition of the propylene-based polymer will not negatively impact the heat resistance of the composition.

As shown in composition CS2, the addition of 15 wt %/o of the propylene-based polymer did not enhance the Bally Flex resistance, indicating that the amount of the propylene-based polymer added is an important feature for good Bally Flex resistance. See also, IE4′ where 2 wt % of the propylene-based polymer did not improve the Bally Flex resistance.

In comparative compositions CS3-CS6, the same amount (10 wt %) of the propylene-based polymer was added into each composition, and there was no improvement in Bally Flex resistance (compare each of CS3-CS6 with the respective CS7-CS10 composition). Actually, each Bally Flex number became worse (lower) as compared to the respective neat resin.

TABLE 2
Inventive and Comparative Compositions

| | CS1 | IE1 | IE2 | CS2 | IE3 | CS3 | CS4 | CS5 | CS6 | CS7 | CS8 | CS9 | CS10 | IE4′ |
|---|---|---|---|---|---|---|---|---|---|---|---|---|---|---|
| INFUSE 9077 | 100 | 95 | 90 | 85 | 90 | | | | | | | | | 98 |
| ENGAGE 8842 | | | | | | 90 | | | | 100 | | | | |
| ENGAGE 8200 | | | | | | | 90 | | | | 100 | | | |
| INFUSE 9107 | | | | | | | | 90 | | | | 100 | | |
| INFUSE 9007 | | | | | | | | | 90 | | | | 100 | |
| RCP FCP80 | | 5 | 10 | 15 | | 10 | 10 | 10 | 10 | | | | | 2 |
| Homo PP 9006 | | | | | 10 | | | | | | | | | |
| Bally Flex failure cycles | 20k | 100k | >100k | 9k | >100k | 23k | 21k | 13k | 13k | 47k | 45k | 20k | 61k | 21k |
| Hardness, Shore A | 51 | 61 | 63 | | 65 | 52 | | 66 | 67 | | | 61 | 64 | |

Note, each amount is a wt %, based on the weight of the composition.

1. A composition comprising a first composition, and wherein the first composition comprises the following components a and b:
a) at least one ethylene/alpha-olefin multi-block interpolymer that comprises a density≤0.880 g/cc and a soft segment melting temperature (SS-Tm)≤2.0° C.;
b) at least one propylene-based polymer; and
wherein component a is present in an amount ≥88 wt %, based on the sum weight of components a and b.

2. The composition of claim 1, wherein the ethylene/alpha-olefin multi-block interpolymer (of component a) has a density from 0.855 g/cc to 0.880 g/cc.

3. The composition of claim 1, wherein the ethylene/alpha-olefin multi-block interpolymer (of component a) has a SS-Tm from −40° C. to 2.0° C.

4. The composition of claim 1, wherein the ethylene/alpha-olefin multi-block interpolymer (of component a) is an ethylene/alpha-olefin multi-block copolymer.

5. The composition claim 1, wherein the ethylene/alpha-olefin multi-block interpolymer (of component a) has a melt index (I2) from 0.2 g/10 min to 10 g/10 min.

6. The composition of claim 1, wherein the ethylene/alpha-olefin multi-block interpolymer (of component a) has a molecular weight distribution (MWD=Mw/Mn) from 1.5 to 4.0.

7. The composition of claim 1, wherein the propylene-based polymer (of component b) has a melt flow rate (MFR) from 1.0 g/10 min to 30 g/10 min.

8. The composition of claim 1, wherein the propylene-based polymer (of component b) has a density from 0.860 g/cc, to 0.930 g/cc.

9. The composition of claim 1, wherein the propylene-based polymer (of component b) is selected from a polypropylene homopolymer, a propylene/ethylene interpolymer or a propylene/alpha-olefin interpolymer.

10. The composition of claim 1, wherein the propylene-based polymer (of component b) is selected from a polypropylene homopolymer or a propylene/ethylene copolymer.

11. The composition of claim 1, wherein the weight ratio of component a to component b is from 5.0 to 40.

12. The composition of claim 1, wherein the ratio of the MFR of component b to the I2 of component a is from 6.0 to 25.

13. The composition of claim 1, wherein the first composition comprises ≤97 wt % of component a, based on the sum weight of components a and b.

14. The composition of claim 1, wherein the first composition comprises from 3.0 wt % to 12 wt % of component b, based on the sum weight of components a and b.

15. The composition of claim 1, wherein the first composition comprises from 60 wt % to 100 wt % of the sum of components a and b, based on the weight of the first composition.

16. The composition of claim 1, wherein the composition further comprises at least one additive.

17. The composition of claim 1, wherein the composition has a “Bally Flex Failure Cycles”≥70 k.

18. The composition of claim 1, wherein the composition has a Shore A Hardness from 20 to 70.

19. An article comprising at least one component formed from the composition of claim 1.

20. A method of forming artificial leather, said method comprising mixing the composition of claim 1.
